(19) United States
(12) Patent Application Publication
(10) Pub. No.: US 2008/0315456 A1
(43) Pub. Date: Dec. 25, 2008

(54) Process for the Manufacturing of a Valve

(75) Inventors: Kurt Ljungbeck, Tyringe (SE); Andres Knutsson, Fjalkinge (SE)

Correspondence Address: Novak, Druce & Quigg LLP, 1300 I Street, N.W., Suite 1000, West Tower, WASHINGTON, DC, 20005, US

(73) Assignee: ARCA SYSTEMS INTERNATIONAL AB, PERSTORP (SE)

(21) Appl. No.: 12/066,252

(22) PCT Filed: Aug. 17, 2006
(86) PCT No.: PCT/SE06/00954

§ 371 Date: Aug. 20, 2008

(30) Foreign Application Priority Data
Sep. 9, 2005 (SE) 0501997-1

(51) Int. Cl. B29C 45/14

(52) U.S. Cl. 264/219

(57) ABSTRACT

A process for the manufacturing of a valve (1) having a rigid carrying body member (2) and a gasket member (3). The gasket member (3) is moulded through means of injection moulding in an elastic thermoplastic material by means of a gasket mould. Said gasket member (3) is then arranged in a body member mould, said body member mould being intended for moulding the carrying body member (2). A thermoplastic material is injected into said body member mould thereby mechanically integrating said gasket member (3) with said carrying body member (2).

### BACKGROUND OF THE INVENTION

1. Field of the Invention

The present invention relates to a process for the manufacturing of a valve having an integrated gasket and a valve achieved through the process.

2. Description of Related Prior Art

Products made of thermoplastic materials can be manufactured by a number of different manufacturing procedures. The most commonly used methods are however, injection moulding, vacuum forming, blow moulding and press moulding.

Valves of butterfly and ball type has been known for some time and they can be manufactured from thermoplastic material. Here injection moulding and press moulding are the most suited manufacturing methods in order to achieve the desired precision. Butterfly valves and ball valves made of thermoplastic materials are mostly used in low pressure systems. Butterfly valves are often used in ventilation appliances where absolute closing isn't necessary. It is also possible to use the valves for fluid media. It will of course be important to have gaskets both in the valve seat as well as at the end of the valve housing. These gaskets are most often separate items which need to be assembled with the valve housing after the moulding procedure.

### SUMMARY OF THE INVENTION

It has through the present invention been made possible to make the manufacturing process more effective and at the same time allowing improvements in mechanical characteristics. Accordingly the invention relates to a process for the manufacturing of a valve having a rigid carrying body member and a gasket member. The invention is characterised in that the gasket member is moulded through means of injection moulding in an elastic thermoplastic material by means of a gasket mould whereupon said gasket member is arranged in a body member mould. Said body member mould is intended for moulding the carrying body member, whereupon a thermoplastic material is injected into said body member mould hereby mechanically integrating said gasket member with said carrying body member.

According to one preferred embodiment of the invention relates to a process for the manufacturing of a valve having a rigid carrying body member and a gasket member. The rigid carrying body member is moulded through means of injection moulding in a body member mould whereupon said rigid carrying body member is arranged in a gasket mould whereupon an elastic thermoplastic material is injected into the gasket mould hereby mechanically integrating said gasket member with said carrying body member.

According to yet one preferred embodiment of the invention the valve further incorporates a butterfly valve member. The butterfly valve member is preferably assembled with the carrying body member after having moulded gasket member and the carrying body. The butterfly valve member is preferably moulded separately.

According to an alternative embodiment of the invention the valve further incorporates a ball valve member. The ball valve member is suitably assembled with the carrying body member after having moulded gasket member and the carrying body. The ball valve member is moulded separately.

The gasket member suitably forms a sealing gasket at the point where the valve is connected to other media. The other media is suitably selected from the group consisting of; a vessel, a tube, a filling station, an emptying station and a combination thereof. The gasket member may according to one embodiment of the invention form a valve seat gasket towards the valve in a valve seat position. According to one embodiment of the invention the gasket member forms at least one sealing gasket at the point where the valve is connected to other media and a valve seat gasket towards the valve in a valve seat position. The at least one sealing gasket and the valve seat gasket are then advantageously connected to form a unit.

According to one embodiment of the invention the sealing gasket is provided with at least one undercut for mechanically bonding it towards the carrying body member. Also the valve seat gasket is suitably provided with at least one undercut for mechanically bonding it towards the carrying body member.

The gasket member is advantageously manufactured of a thermoplastic elastic material having a higher melting point then the thermoplastic material of the carrying body member. This is advantageous in cases where the gasket member is moulded first and the carrying body member is moulded with the gasket member in the mould.

According to a preferred embodiment of the invention the gasket member is manufactured of a thermoplastic elastic material having a lower melting point then the thermoplastic material of the carrying body member. This is advantageous in cases where the gasket member is moulded into the carrying body member already moulded carrying body member.

The invention also relates to a valve having a rigid carrying body member and an elastic gasket member. The invention is characterised in that the gasket member is moulded in an elastic thermoplastic material by means of a gasket mould. Said gasket member is moulded into the carrying body member. The carrying body member is moulded in a body member mould where a thermoplastic material is injected into said body member mould. Said gasket member is hereby mechanically integrated with said carrying body member.

### DESCRIPTION OF AN EMBODIMENT EXAMPLE

The invention is further described together with enclosed drawing showing a selected embodiment of the invention, wherein,

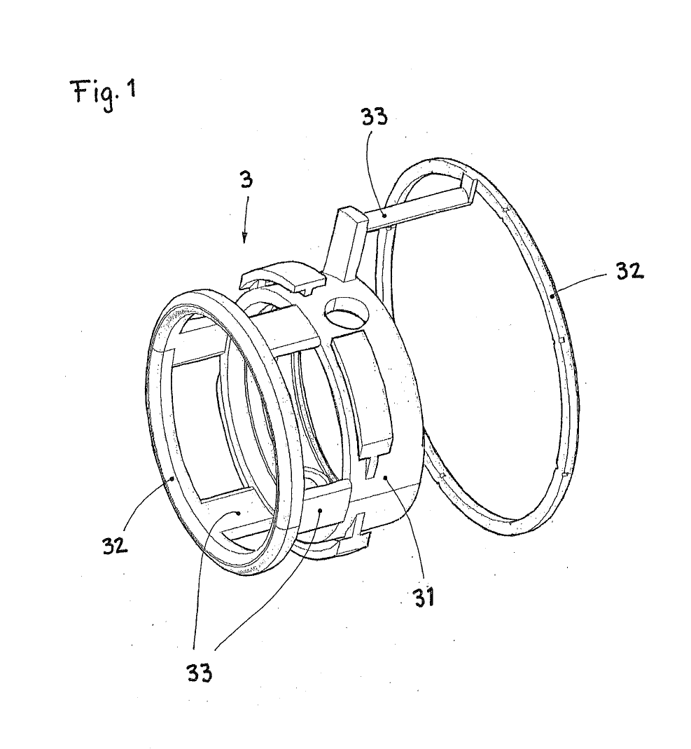

FIG. 1 shows in perspective view a gasket member 3 manufactured according to the invention.

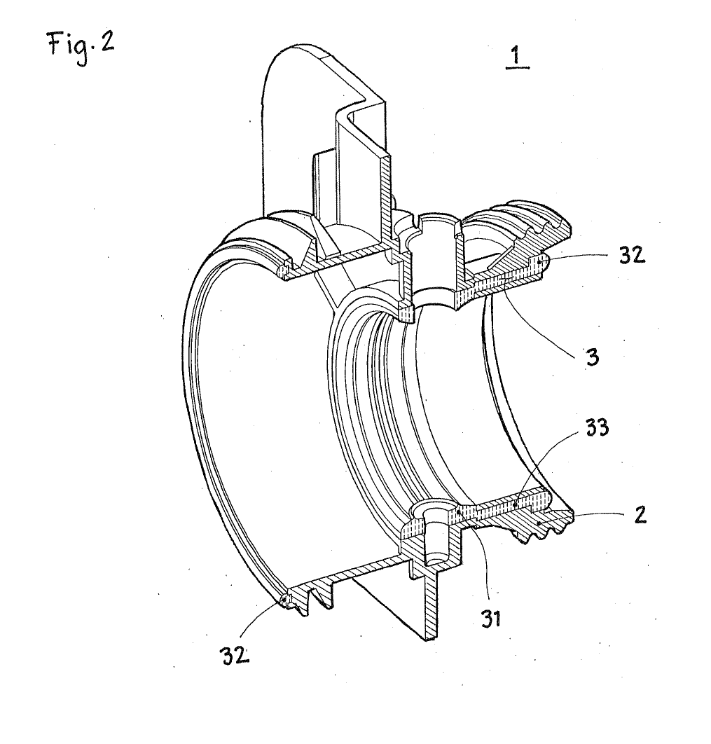

FIG. 2 shows in perspective view a cross-section of a valve 1 manufactured according to the invention.

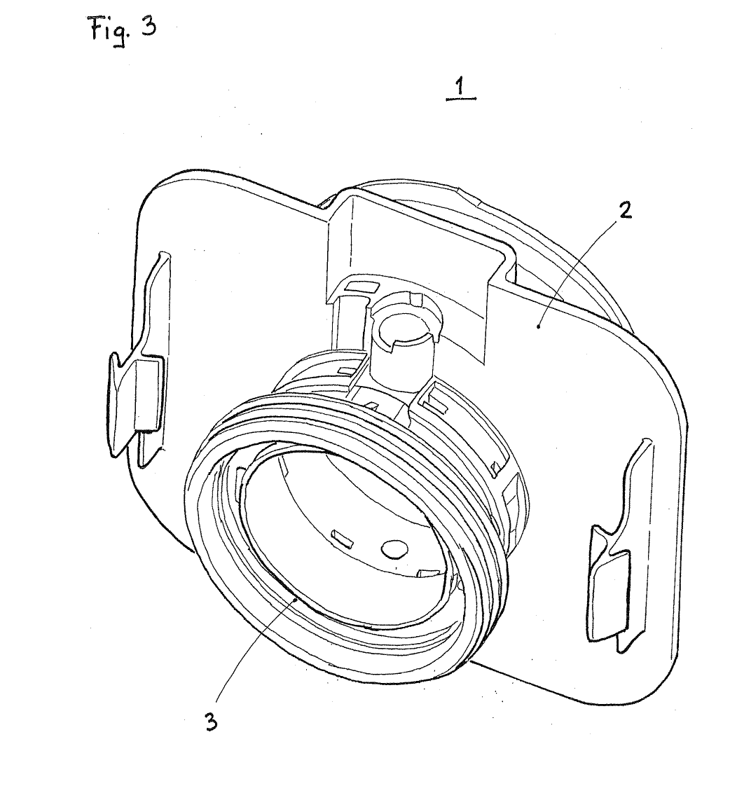

FIG. 3 shows in perspective view a valve 1 according to the invention.

Accordingly, FIG. 1 shows in perspective view a gasket member 3 to a valve 1 (see FIG. 2) having a rigid carrying body member 2 (see FIG. 2) and a gasket member 3 (see also FIG. 2). The gasket member 3 is moulded through means of injection moulding in an elastic thermoplastic material by means of a gasket mould. Said gasket member 3 is arranged in a body member mould, said body member mould being intended for moulding the carrying body member 2 (see FIG. 2). A thermoplastic material is injected into said body member mould hereby mechanically integrating said gasket member 3 with said carrying body member 2 (see FIG. 2). The valve 1 (see FIG. 2) further incorporates a butterfly valve member (not shown). This butterfly valve member (not shown) is assembled with the carrying body member 2 after having moulded the gasket member 3 and the carrying body member 2. The butterfly valve member (not shown) is moulded separately. The gasket member 3 forms sealing gaskets 32 at the point where the valve is connected to other media like a vessel, a tube, a filling station, an emptying station or the like. The gasket member 3 further forms a valve seat gasket 31 towards the valve in a valve seat position. The sealing gaskets 32 and the valve seat gasket 31 are connected to form a unit via channels 33. The gasket member 3 is manufactured of a thermoplastic elastic material having a higher melting point then the thermoplastic material of the carrying body member 2.

It is advantageous to mould the carrying body member 2 prior to the gasket member 3. The carrying body member is then provided with flow channels for the gasket member material during moulding. The carrying body member 2 is then arranged in a gasket mould which is provided with surfaces giving correct shape to the gasket member. The elastic material is then injected into the gasket mould and, of course, also the intended portions of the main body member.

FIG. 2 is discussed together with FIG. 1 above.

FIG. 3 shows in perspective view a valve 1 according to the invention. The valve 1 has a rigid carrying body member 2 and an elastic gasket member 3. The gasket member 3 is moulded in an elastic thermoplastic material by means of a gasket mould. Said gasket member 3 is moulded into the carrying body member which has been moulded by means of a body member mould where a thermoplastic material was injected into said body member mould hereby mechanically integrating said gasket member 3 with said carrying body member 2.

The invention is not limited by the embodiments shown since these can be varied in different ways within the scope of the invention.

1. A process for the manufacturing of a valve (1) having a rigid carrying body member (2) and a gasket member (3) wherein the gasket member (3) is moulded through means of injection moulding in an elastic thermoplastic material by means of a gasket mould whereupon said gasket member (3) is arranged in a body member mould, said body member mould being intended for moulding the carrying body member (2), whereupon a thermoplastic material is injected into said body member mould hereby mechanically integrating said gasket member (3) with said carrying body member (2).

2. A process for the manufacturing of a valve (1) having a rigid carrying body member (2) and a gasket member (3) wherein the rigid carrying body member (2) is moulded through means of injection moulding in a body member mould whereupon said rigid carrying body member (2) is arranged in a gasket mould whereupon an elastic thermoplastic material is injected into the gasket mould hereby mechanically integrating said gasket member (3) with said carrying body member (2).

3. A process according to claim 1 wherein said valve (1) further incorporates a butterfly valve member.

4. A process according to claim 3 wherein said butterfly valve member is assembled with the carrying body member (2) after having moulded gasket member (3) and the carrying body member (2).

5. A process according to claim 1 wherein said valve (1) further incorporates a ball valve member.

6. A process according to claim 5 wherein said ball valve member is assembled with the carrying body member (2) after having moulded gasket member (3) and the carrying body member (3).

7. A process according to claim 3 wherein the butterfly valve member is moulded separately.

8. A process according to claim 5 wherein the ball valve member is moulded separately.

9. A process according to any of the claim 1 wherein the gasket member (3) forms a sealing gasket at the point where the valve is connected to other media.

10. A process according to claim 9 wherein the other media is selected from the group consisting of; a vessel, a tube, a filling station, an emptying station and a combination thereof.

11. A process according to claim 1 wherein the gasket member (3) forms a valve seat gasket (31) towards the valve in a valve seat position.

12. A process according to claim 1 wherein the gasket member (3) forms at least one sealing gasket (32) at the point where the valve is connected to other media and a valve seat gasket (31) towards the valve in a valve seat position.

13. A process according to claim 12 wherein the at least one sealing gasket (32) and the valve seat gasket (31) are connected to form a unit.

14. A process according to claim 9 wherein the sealing gasket (32) is provided with at least one undercut for mechanically bonding it towards the carrying body member (2).

15. A process according to claim 11 wherein the valve seat gasket (31) is provided with at least one undercut for mechanically bonding it towards the carrying body member (2).

16. A process according to claim 1 wherein the gasket member (3) is manufactured of a thermoplastic elastic material having a higher melting point then the thermoplastic material of the carrying body member (2).

17. A process according to claims 2 wherein the gasket member (3) is manufactured of a thermoplastic elastic material having a lower melting point then the thermoplastic material of the carrying body member (2).

18. A valve (1) having a rigid carrying body member (2) and an elastic gasket member (3) wherein the gasket member (3) being moulded in an elastic thermoplastic material by means of a gasket mould and that said gasket member (3) is moulded into the carrying body member by means of a body member mould where a thermoplastic material is injected into said body member mould hereby mechanically integrating said gasket member (3) with said carrying body member (2).
